(19) United States
(12) Patent Application Publication
(10) Pub. No.: US 2018/0234500 A1
(43) Pub. Date: Aug. 16, 2018

(54) REMOTE-CONTROL APPARATUS, REMOTE-CONTROLLED APPARATUS, REMOTE-CONTROL SYSTEM, REMOTE-CONTROL METHOD, REMOTE-CONTROLLED METHOD, AND RECORDING MEDIUM

(71) Applicant: CASIO COMPUTER CO., LTD., Tokyo (JP)

(72) Inventor: Asami Aso, Kokubunji-shi (JP)

(21) Appl. No.: 15/881,190

(22) Filed: Jan. 26, 2018

(30) Foreign Application Priority Data
Feb. 10, 2017 (JP) 2017-023019

(51) Int. Cl. H04L 29/08; G06F 3/0484; G06F 3/0483

(52) U.S. Cl. CPC H04L 67/125; G06F 3/0483; G06F 3/04847; H04L 67/02

(57) ABSTRACT

A remote-control apparatus includes a model information obtainer, a UI generator, and a UI transmitter. The model information obtainer obtains information indicating a model of a controlled apparatus to be remotely controlled. The UI generator generates information for displaying, on a communication terminal, a UI through which the model indicated in the information obtained by the model information obtainer is to be remotely controlled. The UI transmitter transmits the information generated by the UI generator to the communication terminal.

### CROSS-REFERENCE TO RELATED APPLICATION

This application claims the benefit of Japanese Patent Application No. 2017-023019, filed on Feb. 10, 2017, the entire disclosure of which is incorporated by reference herein.

### FIELD

This application relates to a remote-control apparatus, a remote-controlled apparatus, a remote-control system, a remote-control method, a remote-controlled method, and a non-transitory recording medium.

### BACKGROUND

When a projector is used to project and show images, the projector unit and the screen are, in general, separately placed away from the users who watch the images projected by the projector unit onto the screen. For this reason, a remote-controller is usually provided so that images dealt with by the projector can be adjusted.

For example, Unexamined Japanese Patent Application Publication No. 2004-151658 discloses a projector unit and a remote-controller that include lighting means for guiding to operation buttons in order that users can easily make various settings to the projector in the dark.

With the projector disclosed in Unexamined Japanese Patent Application Publication No. 2004-151658, users can easily make various settings in the dark using the lighting means for guiding to operation buttons. However, the user interface (UI) supplied with the projector only allows for menu operations through the use of a menu button and arrow buttons. Thus, users need to use these arrow buttons to make whatever specific settings. Not only this projector but also other projectors generally provide a UI through which users can only operate menus by using hardware buttons, failing to supply an easier-to-use UI that is made suitable for a function to be controlled.

### SUMMARY

A remote-control apparatus includes a transmitter and a processor,

wherein the processor
obtains information indicating a model of a controlled apparatus to be remotely controlled,
generates information for displaying, on a communication terminal, a user interface (UI) through which the model indicated in the obtained information is to be remotely controlled, and
controls the transmitter so that the generated information is transmitted to the communication terminal.

According to the present disclosure, an easier-to-use UI that is made suitable for a function to be controlled can be provided.

### BRIEF DESCRIPTION OF THE DRAWINGS

A more complete understanding of this application can be obtained when the following detailed description is considered in conjunction with the following drawings, in which:

FIG. 1 is a diagram illustrating an example configuration of a remote-control system according to a first embodiment of the present disclosure;

FIG. 2 is a block diagram illustrating a functional configuration of a remote-control apparatus according to the first embodiment;

FIG. 3 shows a specific example of function information by model, as stored in the remote-control apparatus according to the first embodiment;

FIG. 4 shows a specific example of a UI displayed on a communication terminal according to the first embodiment;

FIG. 5 is a block diagram illustrating a functional configuration of a projector according to the first embodiment;

FIG. 6 is a flowchart illustrating a control specifics instruction process handled by the communication terminal according to the first embodiment;

FIG. 7 is a flowchart illustrating a remote-control process handled by the remote-control apparatus according to the first embodiment;

FIG. 8 is a flowchart illustrating a controlled process handled by the projector according to the first embodiment;

FIG. 9 is a block diagram illustrating a functional configuration of a remote-control apparatus according to a variation of the present disclosure;

FIG. 10 shows a specific example of address information stored in the remote-control apparatus according to the variation;

FIG. 11 is a flowchart illustrating a remote-control process handled by the remote-control apparatus according to the variation; and

FIG. 12 is a flowchart illustrating a control specifics instruction process handled by the communication terminal according to the variation.

### DETAILED DESCRIPTION

Embodiments of the present disclosure will now be described with reference to the drawings. Identical reference symbols are given to identical or equivalent parts throughout the drawings.

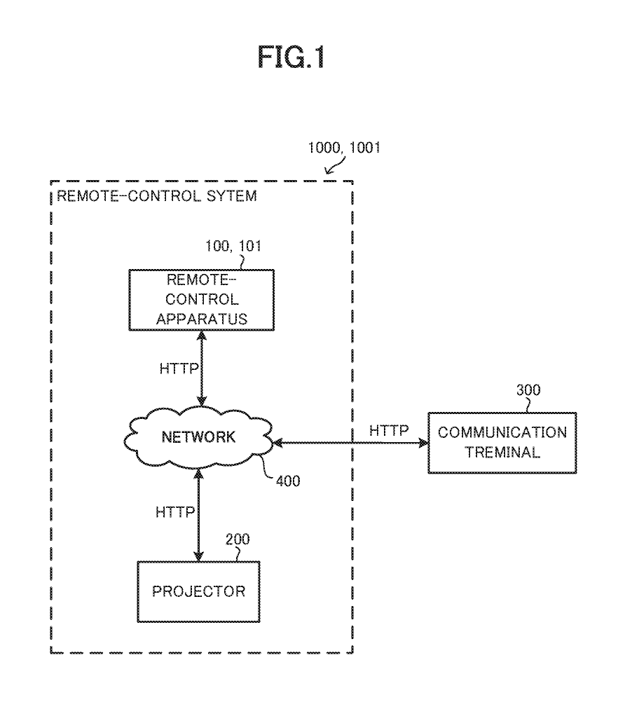

The following describes an example in which a remote-control apparatus 100 according to the first embodiment of the present disclosure is applied to a remote-control system 1000 in FIG. 1. As illustrated in FIG. 1, the remote-control system 1000 includes the remote-control apparatus 100 and a projector 200. The remote-control apparatus 100 and the projector 200 can communicate with each other via a network 400. A communication terminal 300 that includes a Web browser can also communicate with the remote-control apparatus 100 via the network 400. Although any network may be used as the network 400, the Internet is used in this example.

The remote-control apparatus 100 includes a Hypertext Transfer Protocol (HTTP) server, and thus the user can input remote-control specifics addressed to the projector 200 by making access to the HTTP server from the Web browser included in the communication terminal 300. The projector 200 also includes an HTTP server, and thus the remote-control apparatus 100 can remotely control the projector 200 by transmitting to the projector 200 via HTTP the remote-control specifics addressed to the projector 200 that have been inputted from the communication terminal 300.

The aforementioned arrangements enable the user to remotely control the projector 200 by using the communication terminal 300 that includes a Web browser. In addition, the remote-control apparatus 100 is enabled to display an easier-to-use UI on the communication terminal 300 so that settings specific to a function of the projector 200 to be remotely controlled can be displayed on the Web browser in an easier-to-understand manner.

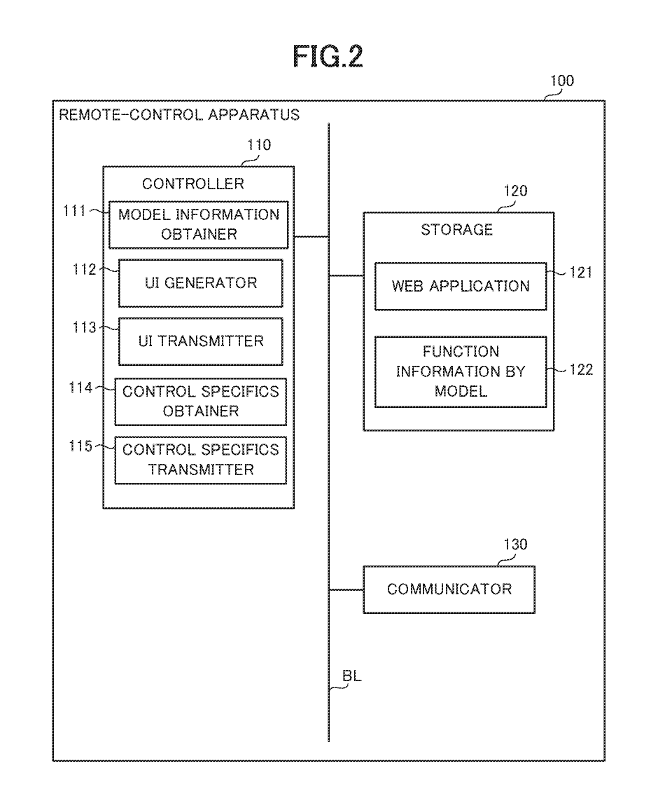

The following describes a functional configuration of the remote-control apparatus 100 according to the present embodiment. As illustrated in FIG. 2, the remote-control apparatus 100 includes a controller 110, a storage 120, and a communicator 130, all of which are electrically connected via a bus line BL.

The controller 110, which includes a processor such as a central processing unit (CPU), controls operations of the remote-control apparatus 100 by reading and executing a program stored in the storage 120.

The storage 120, which includes read only memory (ROM) and/or random access memory (RAM), stores programs to be executed by the controller 110 and other necessary data. The storage 120 (the storage for function information by model) further stores a Web application 121 and function information by model 122.

The Web application 121 includes an HTTP server program and a set of Common Gateway Interface (CGI) programs running on the HTTP server. The set of CGI programs include a program that provides a UI through which the projector 200 is remotely controlled. The Web application 121 includes a Web Application Programming Interface (API) used for invoking the program that provides the UI. The Web application 121 exchanges information with the projector 200 and with the communication terminal 300 via HTTP to remotely control the projector 200 and to provide a UI to the communication terminal 300.

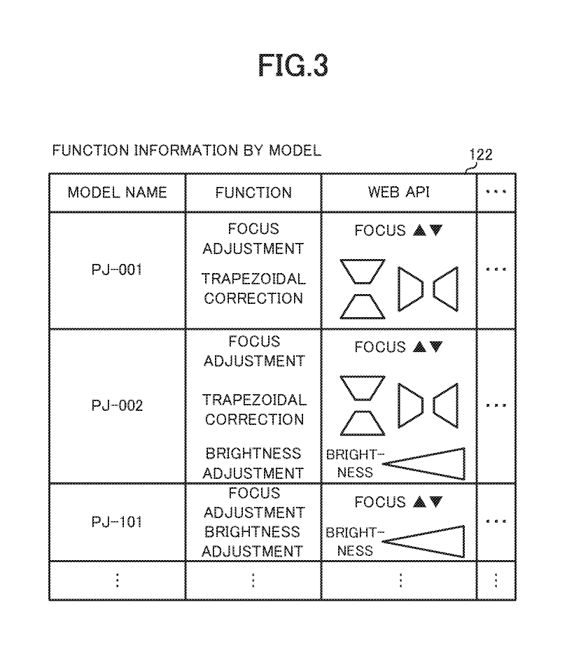

As shown in FIG. 3, the function information by model 122 lists function types (items under “Function”) provided by individual models of the projector 200 and Web API information (items under “Web API”) for providing UIs through which functions of the individual models are remotely controlled. For ease of understanding, FIG. 3 shows images representing the Web API information, but the actual information is Web API information for providing, to the Web browser that has accessed thereto, a UI (an operation screen and inputting and executing operations for remote-control) through which functions of the projector 200 are controlled.

The communicator 130 is a module for communicating with an external apparatus, or, if applicable, a wireless module having an antenna for wirelessly communicating with an external apparatus. For example, the communicator 130 may be a wireless module for wireless communications based on a wireless Local Area Network (LAN), sending and receiving information to and from the projector 200 and the communication terminal 300 under control of the controller 110.

The following describes a functional configuration of the controller 110 in the remote-control apparatus 100. The controller 110 servers as a model information obtainer 111, a UI generator 112, a UI transmitter 113, a control specifics obtainer 114, and a control specifics transmitter 115, by executing the Web application 121 stored in the storage 120.

The model information obtainer 111 obtains information (a model name, for example) indicating the model of the projector 200 (the controlled apparatus) to be remotely controlled.

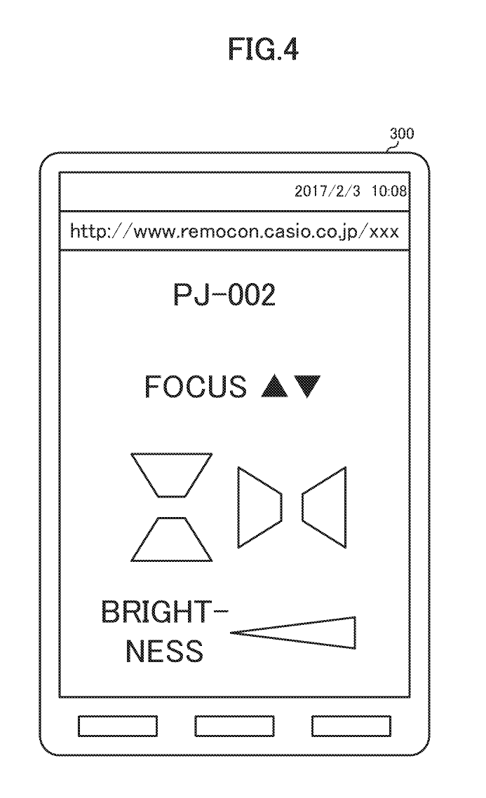

On the basis of the information indicating the model of the projector 200 as obtained by the model information obtainer 111 and on the Web API information included in the function information by model 122, the UI generator 112 generates information for displaying a UI, through which the projector 200 is to be remotely controlled, on the Web browser included in the communication terminal 300. FIG. 4 shows a specific example of the UI displayed on the Web browser in the communication terminal 300 that has received the information.

The UI transmitter 113 transmits the information generated by the UI generator 112 to the communication terminal 300 via the communicator 130.

The control specifics obtainer 114 obtains, via the communicator 130, the information regarding control specifics addressed to the projector 200 as transmitted by the communication terminal 300.

The control specifics transmitter 115 transmits the information regarding remote-control specifics, as obtained by the control specifics obtainer 114, to the projector 200 via the communicator 130.

The foregoing has described a configuration of the remote-control apparatus 100.

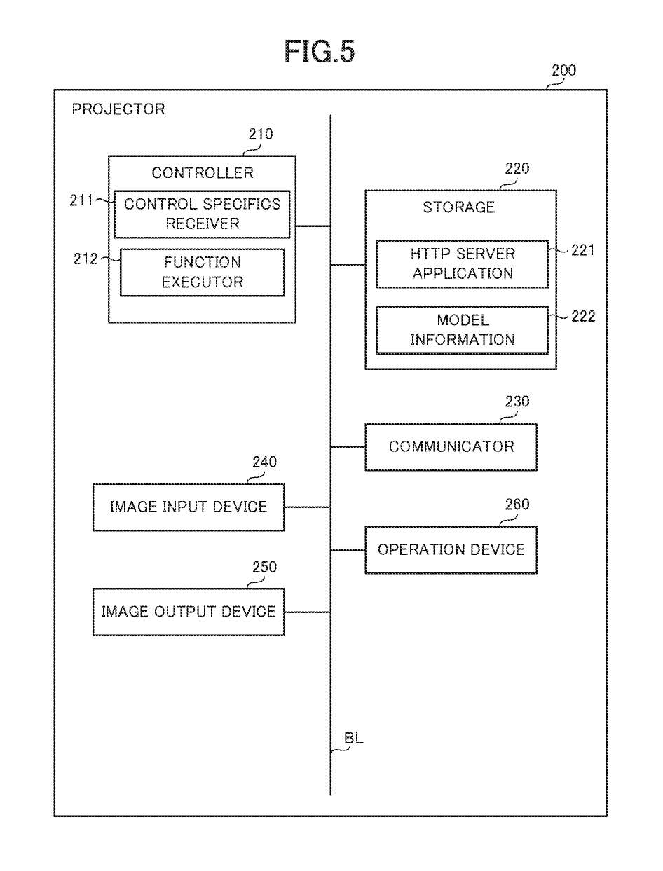

The following describes a functional configuration of the projector 200. The projector 200 is a controlled apparatus remotely controlled by the remote-control apparatus 100. As illustrated in FIG. 5, the projector 200 includes a controller 210, a storage 220, a communicator 230, an image input device 240, an image output device 250, and an operation device 260.

The controller 210, which includes a processor such as a CPU, controls operations of the projector 200 by executing a program stored in the storage 220.

The storage 220, which includes ROM and/or RAM, stores programs to be executed by the controller 210 and other necessary data. In addition, the storage 220 stores an HTTP server application 221 and model information 222.

The HTTP server application 221 is an HTTP server program running on the operating system (OS) on the projector 200. Execution of the HTTP server application 221 by the controller 210 enables the projector 200 to exchange information regarding remote-control with the Web application 121 on the remote-control apparatus 100 via HTTP. The model information 222 represents, for example, a model name of the projector 200, and is used when model information is transmitted to the remote-control apparatus 100.

The communicator 230 is a module for communicating with an external apparatus, or, if applicable, a wireless module having an antenna for wirelessly communicating with an external apparatus. For example, the communicator 230 may be a wireless module for wireless communications based on a wireless LAN, sending and receiving information to and from the remote-control apparatus 100 under control of the controller 210.

The image input device 240 is an interface through which an image signal is inputted via a signal cable or the like.

The image output device 250 projects image signals inputted to the image input device 240 to present the signals as images. The image output device 250 includes devices for displaying images including a light source lamp and a projection lens, and mechanisms for adjusting images including a focus adjuster, a trapezoidal corrector, and a brightness adjuster, all of which are not illustrated.

The operation device 260, which includes, for example, operation buttons and/or a touch panel, is an interface for accepting user operations.

The following describes a functional configuration of the controller 210 in the projector 200. The controller 210 includes, in a functional sense, a control specifics receiver 211 and a function executor 212.

The control specifics receiver 211 obtains, via the communicator 230, information regarding control specifics as transmitted by the remote-control apparatus 100. The control specifics receiver 211 is implemented through execution by the controller 210 of the HTTP server application 221 stored in the storage 220.

The function executor 212 executes a specified function on the local apparatus (projector 200) on the basis of the information obtained by the control specifics receiver 211. For example, the function executor 212 controls the image-adjusting mechanism included in the image output device 250. The function executor 212 changes the brightness of the light source lamp included in the image output device 250, adjusts the focus of the projection lens, makes a trapezoidal correction, and the like. The function executor 212 may be implemented in the form of a CGI program that runs on the HTTP server and is started through execution of the HTTP server application 221 by the controller 210.

The communication terminal 300 is a terminal apparatus having a Web browser, such as a smart phone. In addition to a smart phone, any terminal apparatus having a Web browser may be used as the communication terminal 300, and thus descriptions of its functional configuration are omitted here.

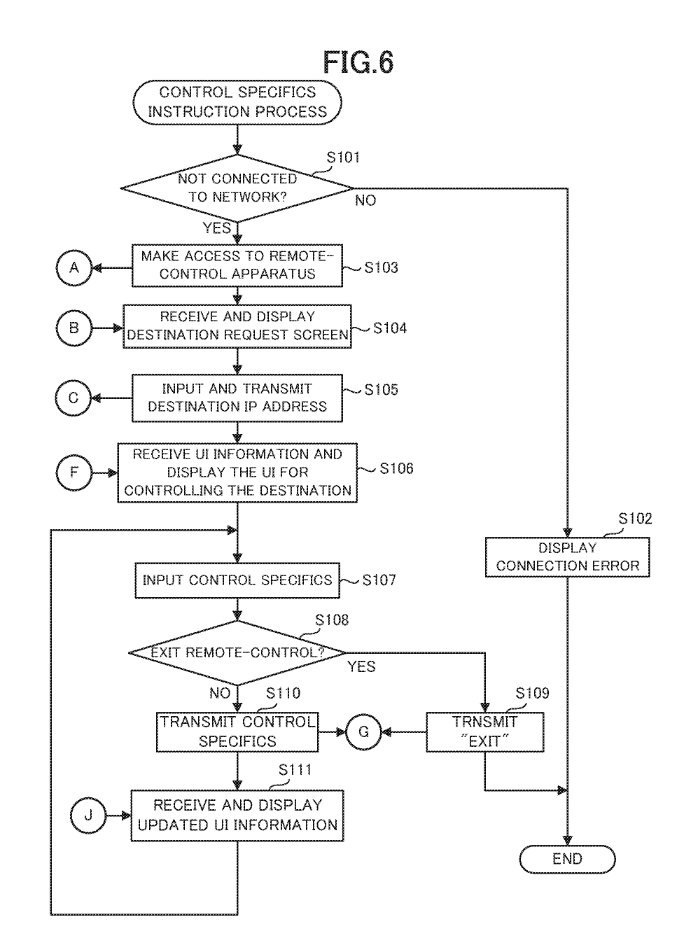

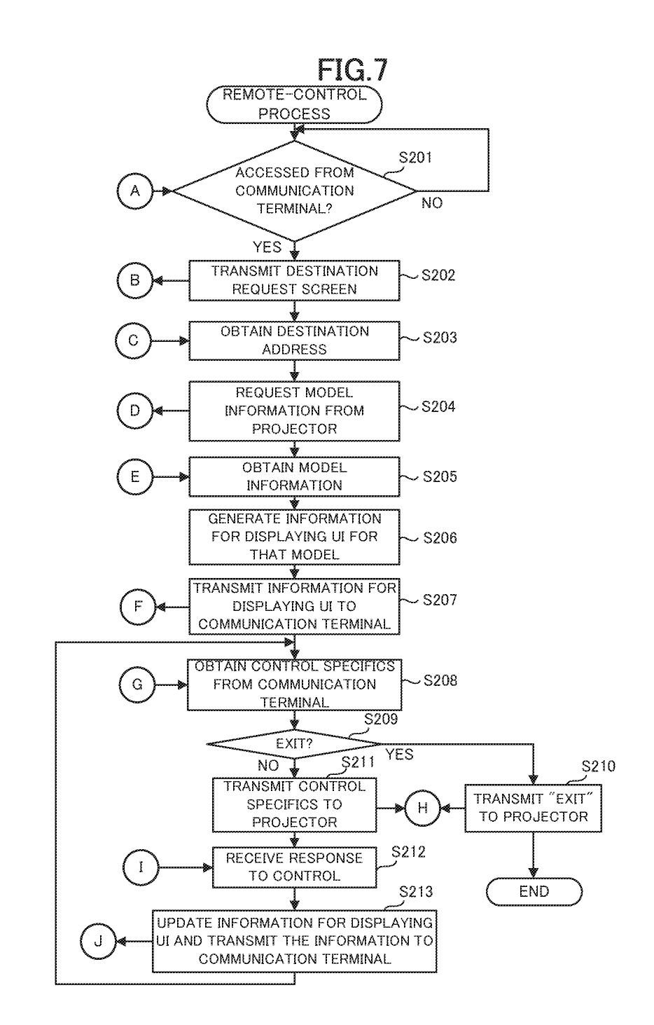

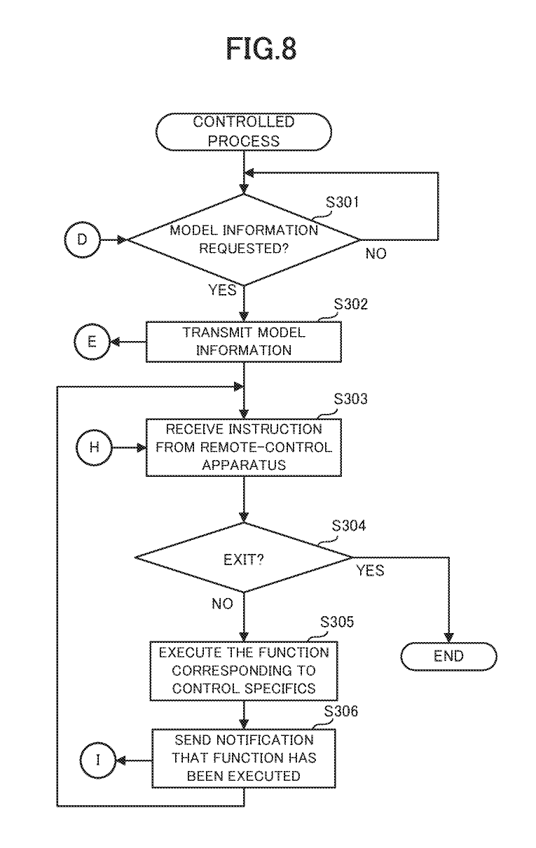

With reference to the flowcharts in FIGS. 6 to 8, the process of remotely controlling the projector 200 using the remote-control apparatus 100 and the communication terminal 300 will now be described on a step-by-step basis. This process includes three processes: a control specifics instruction process handled by the communication terminal 300 (FIG. 6), a remote-control process handled by the remote-control apparatus 100 (FIG. 7), and a controlled process handled by the projector 200 (FIG. 8). For ease of understanding, these three processes are described in time sequence. Since the processes are described in time sequence, the description will refer to different flowcharts across the processes along with the flow of information being transmitted and received. To indicate reference to another flowchart, an arrow and an alphabetic letter (A to L) are put to the side of the applicable step. An alphabetic letter represents the position on another flowchart to be referred to.

The remote-control process handled by the remote-control apparatus 100 starts upon startup of the remote-control apparatus 100, and shifts to the standby mode when the remote-control apparatus 100 starts waiting for access from the communication terminal 300 (FIG. 7, step S201). The controlled process handled by the projector 200 starts upon startup of the projector 200, and shifts to the standby mode when the projector 200 starts waiting for access from the remote-control apparatus 100 (FIG. 8, step S301). The control specifics instruction process starts when the user starts the Web browser on the communication terminal 300 and enters a Uniform Resource Locator (URL) of the remote-control apparatus 100.

First, as shown in FIG. 6, the Web browser on the communication terminal 300 determines whether the communication terminal 300 is connected to a network (the Internet, for example) (step S101). If the terminal is not connected to a network (No in step S101), the Web browser displays Connection Error (step S102) to exit the process. In this case, when the user connects the communication terminal 300 to a network and then enters a URL of the remote-control apparatus 100 on the Web browser, the control specifics instruction process starts from step S101 again.

If the terminal is connected to a network (Yes in step S101), the Web browser makes access to the remote-control apparatus 100 (step S103, A).

As shown in FIG. 7, the controller 110 in the remote-control apparatus 100, after started up, determines whether the communication terminal 300 has made access thereto (step S201, A). If the communication terminal 300 has not made access to the remote-control apparatus (No in step S201), the controller 110 returns to step S201 to wait for access from the communication terminal 300 again. If the communication terminal 300 has made access thereto (Yes in step S201), the controller 110 transmits information regarding a destination request screen to the communication terminal 300 (step S202, B). The destination request screen asks for an IP address of the projector 200 to be remotely controlled.

In step S202, the controller 110 preferably obtains a User-Agent value from the communication terminal 300 that has made access thereto to estimate the type (personal computer (PC), tablet, smart phone, mobile phone, or the like) and screen size of the communication terminal 300 on the basis of the value. The controller 110 then preferably transmits to the communication terminal 300 the information regarding the destination request screen that is made suitable for the screen size of the communication terminal 300 as estimated on the basis of the User-Agent value.

When the controller 110 in the remote-control apparatus 100 transmits the information regarding the destination request screen, the Web browser on the communication terminal 300 receives the information and displays the destination request screen on the Web browser screen on the communication terminal 300, as shown in FIG. 6 (step S104, B). When the user enters, on this screen, an Internet Protocol (IP) address (destination address) of the projector 200 to be remotely controlled, the Web browser on the communication terminal 300 transmits the destination address to the remote-control apparatus 100 (step S105, C).

When the communication terminal 300 transmits the destination address, the controller 110 in the remote-control apparatus 100 obtains the destination address (the IP address of the projector 200 to be connected), as shown in FIG. 7 (step S203, C). In this step, the controller 110 is equivalent to an address obtainer. Then, the model information obtainer 111 makes access to the projector 200 identified by the destination address and asks for model information (step S204, D).

As shown in FIG. 8, the controller 210 in the projector 200, after started up, determines whether the remote-control apparatus 100 has asked for model information (step S301, D). If the remote-control apparatus 100 has not asked for model information (No in step S301), the controller 210 returns to step S301 to wait for a request for model information again. If the remote-control apparatus 100 has asked for model information (Yes in step S301), the controller 210 transmits the model information 222 (a model name, for example) stored in the storage 220 (step S302, E). In step S302, the controller 210 is equivalent to a model information transmitter. Step S302 may be called a model information transmitting step.

When the controller 210 in the projector 200 transmits the model information, the model information obtainer 111 in the remote-control apparatus 100 obtains the model information via the communicator 130, as shown in FIG. 7 (step S205, E). Step S205 may be called a model information obtaining step. Next, on the basis of the model information obtained by the model information obtainer 111 and on the function information by model 122 stored in the storage 120, the UI generator 112 generates information for displaying a UI on the Web browser included in the communication terminal 300, through which UI the destination projector 200 is to be remotely controlled (step S206). Step S206 may be called a UI generating step.

The UI transmitter 113 transmits the information for displaying the UI on the Web browser in the communication terminal 300, as generated by the UI generator 112, to the communication terminal 300 via the communicator 130 (step S207, F). Step S207 may be called a UI transmitting step. In step S207, the UI transmitter 113 may transmit, to the communication terminal 300, information for displaying the UI made suitable for the screen size of the communication terminal 300, as estimated on the basis of the User-Agent value of the communication terminal 300.

When the controller 113 in the remote-control apparatus 100 transmits the information, the Web browser in the communication terminal 300 receives the information and displays the UI through which the projector 200 is to be remotely controlled, as shown in FIG. 6 (step S106, F).

The user enters specifics of remote-control on the UI screen displayed on the Web browser in the communication terminal 300 (step S107). Then, the Web browser in the communication terminal 300 determines whether the specifics of remote-control entered by the user represent “exit remote-control” (step S108). If the user has entered “exit remote-control” (Yes in step S108), the Web browser transmits “exit” to the remote-control apparatus 100 (step S109, G) and exits the control specifics instruction process.

If the specifics of remote-control entered by the user are not “exit remote-control” (No in step S108), the Web browser in the communication terminal 300 transmits the specifics to the remote-control apparatus 100 (step S110, G). By transmitting the specifics, the communication terminal 300 specifies details of the remote-control.

When the Web browser in the communication terminal 300 transmits “exit” or specifics of remote-control, the control specifics obtainer 114 in the remote-control apparatus 100 obtains the information via the communicator 130, as shown in FIG. 7 (step S208, G). Step S208 may be called a control specifics obtaining step. Then, it is determined whether the obtained information represents “exit” (step S209). If the obtained information represents “exit” (Yes in step S209), the control specifics transmitter 115 transmits “exit” to the projector 200 via the communicator 130 (step S210, H) and exits the remote-control process. If the obtained control specifics do not represent “exit” (No in step S209), the control specifics transmitter 115 transmits the specifics to the projector 200 via the communicator 130 (step S211, H). Step S211 may be called a control specifics transmitting step.

When the control specifics transmitter 115 in the remote-control apparatus 100 transmits an instruction representing “exit” or containing control specifics, the control specifics receiver 211 in the projector 200 receives the instruction, as shown in FIG. 8 (step S303, H). Step S303 may be called a control specifics receiving step.

Then, the controller 210 determines whether the instruction represents “exit” (step S304). If the instruction represents “exit” (Yes in step S304), the controller 210 exits the controlled process.

If the instruction does not represent “exit” (No in step S304), the function executor 212 executes the function corresponding to the control specifics received by the control specifics receiver 211 (step S305). Step S305 may be called a function executing step. Then, the controller 210 transmits, to the remote-control apparatus 100 via the communicator 230, the information representing that the function corresponding to the control specifics has been executed (step S306, I), and returns to step S303. The “information representing that the function has been executed” may be information indicating a simple response such as ACK (ACKnowledgement) or may be information containing various setting values (such as brightness, focus setting, and trapezoidal correction values) established after the function is executed.

When the controller 210 in the projector 200 transmits the information representing that the function has been executed, the controller 110 in the remote-control apparatus 100 receives the information taking it as a response to the remote-control, as shown in FIG. 7 (step S212, I). On the basis of the received response to the remote-control, the UI generator 112 updates the information for displaying a UI on the Web browser in the communication terminal 300, and then the UI transmitter 113 transmits the updated information to the communication terminal 300 (step S213, J). Then, the processing returns to step S208.

When the UI transmitter 113 in the remote-control apparatus 100 transmits the updated information, the Web browser in the communication terminal 300 receives the updated information and displays a UI through which the projector 200 is to be remotely controlled, as shown in FIG. 6 (step S111, J). Then, the processing returns to step S107.

The foregoing has described the three processes: the control specifics instruction process handled by the communication terminal 300 (FIG. 6), the remote-control process handled by the remote-control apparatus 100 (FIG. 7), and the controlled process handled by the projector 200 (FIG. 8). The above-described arrangements enable the remote-control apparatus 100 to display, on the Web browser in the communication terminal 300, an easier-to-use UI that is made suitable for a function of the projector 200.

As the communication terminal 300, the user can use any apparatus that includes a Web browser. On the communication terminal 300, the Web browser handles the aforementioned various processes, and thus there is no need for the user to install any special application software on the communication terminal 300 for the purpose of remotely controlling the projector 200. In addition, the remote-control apparatus 100 is capable of supplying a UI suitable for the type and screen size of the communication terminal 300, and thus the user can use an easier-to-use UI irrespective of the type and screen size of the communication terminal 300.

The projector 200 is remotely controlled by the remote-control apparatus 100, and thus there is no need for the communication terminal 300 to directly communicate with the projector 200. Accordingly, the projector 200 can block any access other than that from the remote-control apparatus 100 to ensure greater security including, for example, preventing malicious access to the projector 200.

The communication terminal 300 need only make access to the same remote-control apparatus 100 at any time, and thus the user can easily make the access by bookmarking the URL of the remote-control apparatus 100 on the Web browser in the communication terminal 300. Furthermore, the user can remotely control any projector 200 by entering an IP address of the projector 200.

(Variations)

In the foregoing embodiment, the user needs to enter an IP address of the projector 200 during the control specifics instruction process handled by the communication terminal 300. The following describes a variation that eliminates the need for the user to enter an IP address of the projector 200.

The system configuration of a remote-control system 1001 according to the variation of the present disclosure is the same as that of the remote-control system 1000 illustrated in FIG. 1. The only difference between the foregoing embodiment and the variation is that the remote-control apparatus 100 according to the first embodiment is replaced by a remote-control apparatus 101.

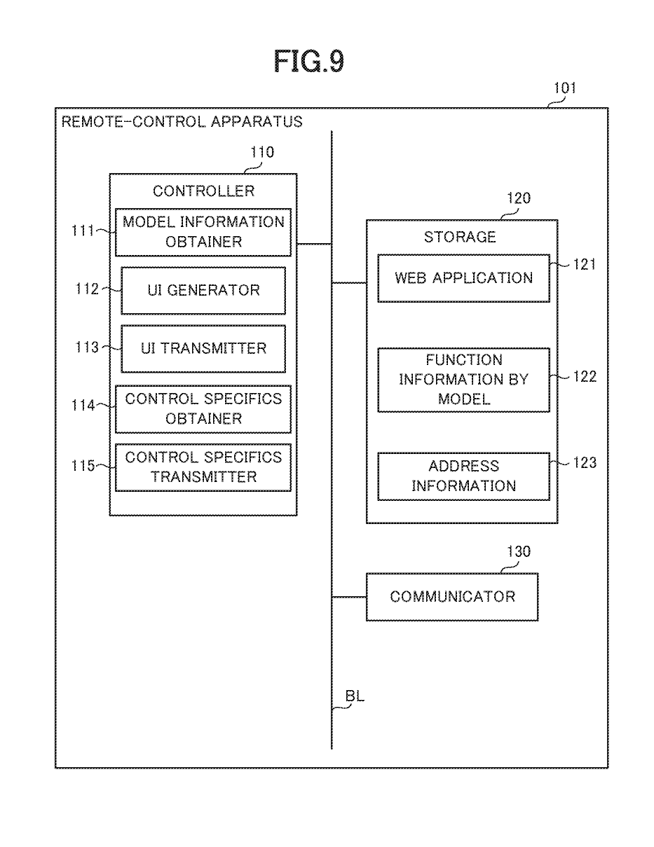

The remote-control apparatus 101 according to the variation is different from the remote-control apparatus 100 according to the first embodiment in that the storage 120 (the address information storage) stores address information 123, as seen in FIG. 9.

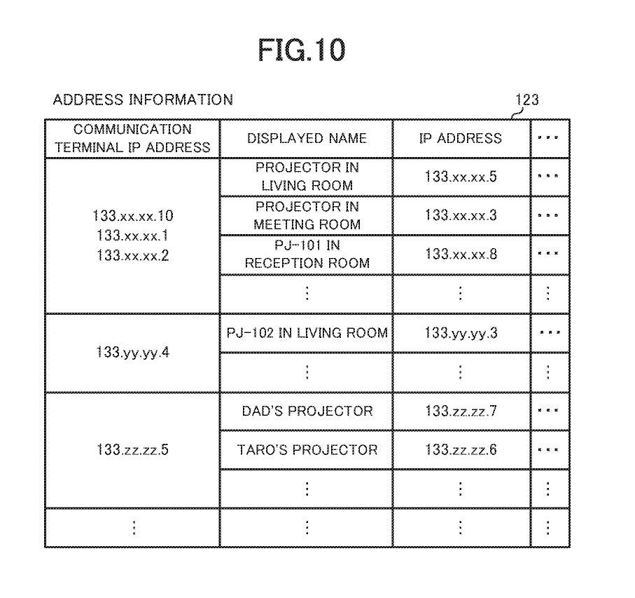

As shown in FIG. 10, the address information 123 is the stored information listing, by IP address of the communication terminal 300, IP addresses of the individual projectors 200 associated with names (displayed names) used for selecting from the projectors 200. Displayed names may include not only model names but also other information such as installation sites, owners, and users of the projectors 200. After acquiring the projector 200, the user needs to store the address information 123, which includes a name (displayed name) used for selecting the projector 200 and an IP address allocated to the projector 200 along with an IP address of the communication terminal 300, into the storage 120. Hence, the remote-control apparatus 101 includes some application software used by the user for storing a displayed name and an IP address of the projector 200 along with an IP address of the communication terminal 300 into the storage 120.

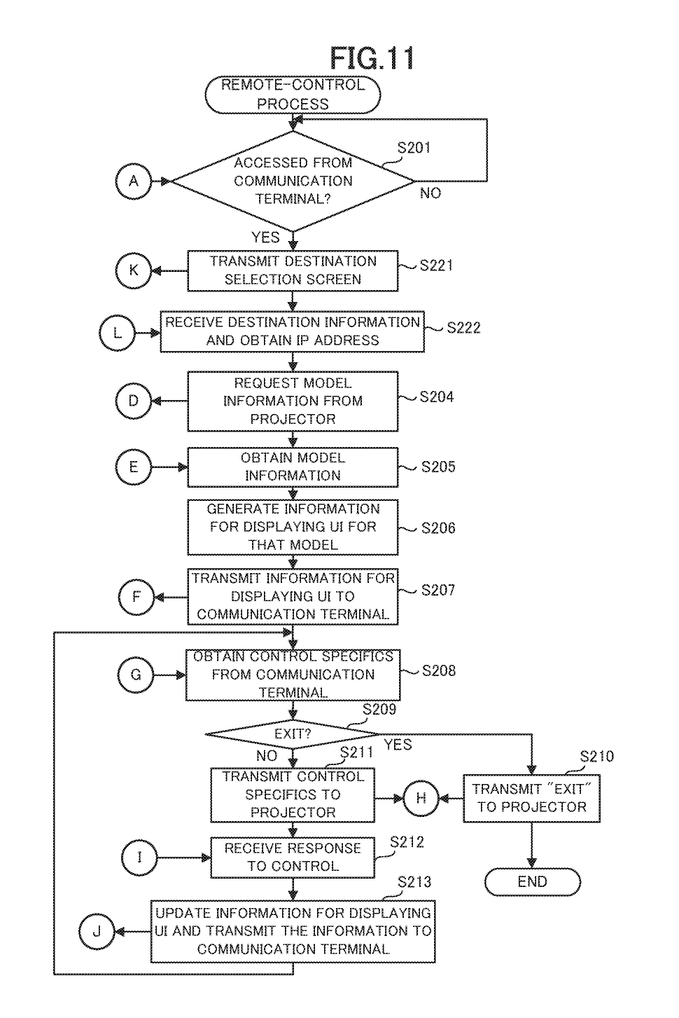

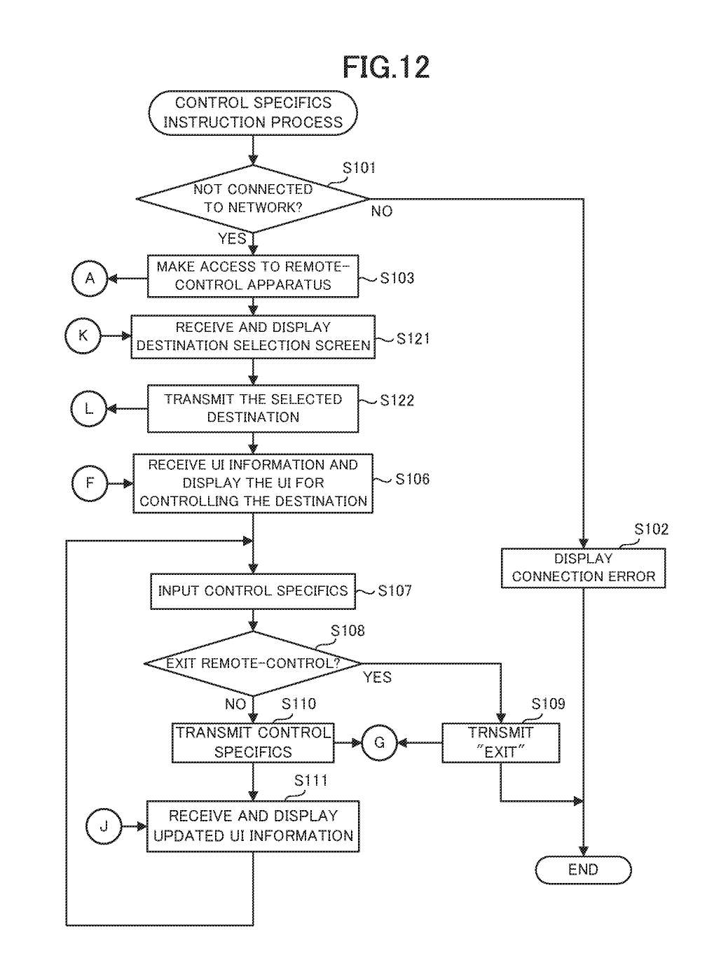

The controlled process handled by the projector 200 according to the variation is the same as that handled by the projector 200 according to the foregoing embodiment. The remote-control process handled by the remote-control apparatus 101 according to the variation is the same as the that handled by the remote-control apparatus 100 as described with reference to FIG. 7, except that step S202 and step S203 are replaced by step S221 and step S222, as shown in FIG. 11. The control specifics instruction process handled by the communication terminal 300 according to the variation is the same as that handled by the communication terminal 300 as described with reference to FIG. 6, except that step S104 and step S105 are replaced by step S121 and step S122, as shown in FIG. 12. Thus, the following description is provided focusing on the differences with reference to FIGS. 11 and 12.

In step S221, on the basis of the address information 123, the controller 110 in the remote-control apparatus 101 transmits information regarding a destination selection screen to the communication terminal 300, as shown in FIG. 11 (step S221, K). The destination selection screen prompts the user to select the projector 200 to be remotely controlled. For example, assuming that the address information 123 in FIG. 10 is stored in the storage 120 and that the IP address of the communication terminal 300 is 133.xx.xx.10, the controller 110 transmits information regarding the screen that displays three options: “Projector in living room”, “Projector in meeting room”, and “PJ-101 in reception room” to the communication terminal 300.

In step S221, the controller 110 preferably obtains a User-Agent value from the communication terminal 300, estimates the screen size of the communication terminal 300 on the basis of the value, and transmits information regarding the destination selection screen that is made suitable for the screen size to the communication termination 300.

When the controller 110 in the remote-control apparatus 101 transmits the information regarding the destination selection screen, the Web browser in the communication terminal 300 receives the information and displays the destination selection screen on the Web browser screen on the communication terminal 300, as shown in FIG. 12 (step S121, K). When the user selects, on this screen, a displayed name of the projector 200 to be remotely controlled, the Web browser in the communication terminal 300 transmits the destination information, which is the information (the displayed name, for example) representing the projector 200 selected by the user, to the remote-control apparatus 101 (step S122, L).

When the communication terminal 300 transmits the information indicating the destination, the controller 110 in the remote-control apparatus 101 receives the information, and refers to the address information 123 to obtain the IP address (destination address) of the destination projector 200 indicated in the information, as shown in FIG. 11 (step S222, L). In this step, the controller 110 is equivalent to an address obtainer.

The subsequent steps are the same as those in the control specifics instruction process handled by the communication terminal 300 as described with reference to FIG. 6 and those in the remote-control process handled by the remote-control apparatus 100 as described with reference to FIG. 7.

The remote-control apparatus 101 according to the variation can obtain information regarding an IP address of the destination projector 200 by referring to the address information 123, without the need for the communication terminal 300 to transmit an IP address of the projector 200. Thus, there is no need for the user to enter an IP address of the projector 200.

The foregoing has described individual embodiments, but these embodiments may be combined as appropriate. For example, in step S221 in the remote-control process according to the variation, the controller may transmit information for displaying both of the destination selection screen and the destination request screen to the communication terminal 300. In this case, in step S222, upon receipt of any information indicating a selected projector, the controller may refer to the address information 123 to obtain the corresponding IP address, or, upon receipt of an IP address of the destination, the controller may use the IP address itself. In this way, the user can remotely control the projector 200 by selecting one from options displayed on the destination selection screen, and furthermore, the user can remotely control another projector 200 not listed in the options displayed on the destination selection screen by entering an IP address of the projector 200.

The foregoing embodiments are examples only, and thus configurations and processing details related to the remote-control system are not limited to those described in the foregoing embodiments. For example, instead of the Internet, a home LAN may be used as the network. Targets of remote-control are not limited to the projector 200. For example, equipment like a television, a video system, or an air conditioner can be remotely controlled by the remote-control apparatus 100, 101 and the communication terminal 300 if the equipment includes the controller 210, the storage 220, and the communicator 230.

In any of the foregoing embodiments, individual functions can be implemented with general computers. For example, the foregoing embodiments are described with the assumption that programs to be executed by the controller 110, 210 are stored in ROM in the storage 120, 220 in advance. Instead, a computer may be configured so that the above-described individual functions can be implemented by distributing the programs stored in a non-transitory computer-readable recording medium, such as a Universal Serial Bus (USB) memory, a flexible disk, a Compact Disc Read-Only Memory (CD-ROM), a hard disk drive (HDD), a digital versatile disc (DVD), or a magneto-optical disc (MO), and reading and installing the programs onto the computer. If, for example, the individual functions are separately or collaboratively implemented by the OS and applications, only non-OS portions may be stored in the non-transitory recording medium.

Furthermore, each program may be distributed via a communication network by superimposing the program on a carrier wave. For example, the programs may be uploaded to a server or bulletin board system (BBS) on a communication network to enable the programs to be downloaded via a network. In this case, the remote-control apparatus 100, 101 and the projector 200 may be configured so that the above-described processes can be performed by downloading and starting these programs, and executing the programs under control of the OS as with other application programs.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A remote-control apparatus comprising a transmitter and a processor,
wherein the processor
obtains information indicating a model of a controlled apparatus to be remotely controlled,
generates information for displaying, on a communication terminal, a user interface (UI) through which the model indicated in the obtained information is to be remotely controlled, and
controls the transmitter so that the generated information is transmitted to the communication terminal.

2. The remote-control apparatus according to claim 1, wherein the processor generates information for displaying a UI on the communication terminal, the UI being different in terms of presentation on a screen from a UI that is preset in the controlled apparatus.

3. The remote-control apparatus according to claim 1, wherein the processor
obtains, from the communication terminal that has received the transmitted information, information indicating specifics of remote-control to be performed on the controlled apparatus, and
controls the transmitter so that the obtained information is transmitted to the controlled apparatus.

4. The remote-control apparatus according to claim 1, wherein the processor
obtains a screen size of the communication terminal, and
transmits information for displaying the UI that is made suitable for the screen size on the communication terminal.

5. The remote-control apparatus according to claim 1, further comprising:
a storage storing the model and a function executable by the model, the model and the function being associated with each other,
wherein the processor generates, by referring to the storage, information for displaying, on the communication terminal, a UI through which the function corresponding to the model indicated in the obtained information is to be controlled.

6. The remote-control apparatus according to claim 1, wherein the processor
obtains an address of the controlled apparatus, and
obtains information indicating a model of the controlled apparatus from the controlled apparatus specified by the obtained address.

7. The remote-control apparatus according to claim 5, further comprising:
a storage storing a name and an address of the controlled apparatus, the name and the address being associated with each other,
wherein the processor refers to the storage and obtains an address of the controlled apparatus corresponding to a name of the controlled apparatus, the name being specified by the communication terminal.

8. A remote-controlled apparatus comprising a processor,
wherein the processor controls a transmitter so that information indicating a model of the remote-controlled apparatus is transmitted to a remote-control apparatus that transmits, to a communication terminal, information for displaying, on the communication terminal, a UI through which the model of the remote-controlled apparatus is to be remotely controlled.

9. A remote-control system comprising:
a remote-control apparatus that comprises a transmitter and a processor; and
a remote-controlled apparatus that is remotely controlled by the remote-control apparatus and that comprises a processor,
wherein the processor in the remote-control apparatus
obtains information indicating a model of the controlled apparatus,
generates information for displaying, on a communication terminal, a UI through which the model indicated in the obtained information is to be remotely controlled, and
controls the transmitter so that the generated information is transmitted to the communication terminal, and
wherein the processor in the controlled apparatus controls a transmitter so that information indicating a model of the remote-controlled apparatus is transmitted to the remote-control apparatus.

10. A remote-control method comprising:
a model information obtaining step of obtaining information indicating a model of a controlled apparatus to be remotely controlled;
a UI generating step of generating information for displaying, on a communication terminal, a UI through which the model indicated in the information obtained in the model information obtaining step is to be remotely controlled; and
a UI transmitting step of transmitting the information generated in the UI generating step to the communication terminal.

11. A remote-controlled method comprising:
a step of controlling a transmitter so that information indicating a model of a remote-controlled apparatus is transmitted to a remote-control apparatus that transmits, to a communication terminal, information for displaying, on the communication terminal, a UI through which the model of the remote-controlled apparatus is to be remotely controlled.

12. A non-transitory recording medium encoded with a computer-readable program that enables a computer to execute functions as:
a model information obtaining step of obtaining information indicating a model of a controlled apparatus to be remotely controlled;
a UI generating step of generating information for displaying, on a communication terminal, a UI through which the model indicated in the information obtained in the model information obtaining step is to be remotely controlled; and
a UI transmitting step of transmitting the information generated in the UI generating step to the communication terminal.

13. A non-transitory recording medium encoded with a computer-readable program that enables a computer to execute functions as:
a step of controlling a transmitter so that information indicating a model of a remote-controlled apparatus is transmitted to a remote-control apparatus that transmits, to a communication terminal, information for displaying, on the communication terminal, a UI through which the model of the remote-controlled apparatus is to be remotely controlled.

14. The remote-control apparatus according to claim 4, wherein the processor generates information for displaying a UI on the communication terminal, the UI being different in terms of presentation on a screen from a UI that is preset in the controlled apparatus.

15. The remote-control apparatus according to claim 5, wherein the processor generates information for displaying a UI on the communication terminal, the UI being different in terms of presentation on a screen from a UI that is preset in the controlled apparatus.

16. The remote-control apparatus according to claim 6, wherein the processor generates information for displaying a UI on the communication terminal, the UI being different in terms of presentation on a screen from a UI that is preset in the controlled apparatus.

17. The remote-controlled apparatus according to claim 8, wherein the UI through which the model of the remote-controlled apparatus is to be remotely controlled is different in terms of presentation on a screen from a UI that is preset in the controlled apparatus.
